(19) United States
(12) Patent Application Publication
(10) Pub. No.: US 2003/0170066 A1
(43) Pub. Date: Sep. 11, 2003

(54) Lotion applicator assembly

(76) Inventor: Tracy G. White, Seaside Park, NJ (US)

Correspondence Address: CLIFFORD G. FRAYNE, Suite 7A, 136 Drum Point Road, Brick, NJ, 08723, US

(21) Appl. No.: 10/366,150

(22) Filed: Feb. 13, 2003

Related U.S. Application Data
(60) Provisional application No. 60/357,790, filed on Feb. 20, 2002.

(51) Int. Cl. A46B 5/02; B43K 5/00

(52) U.S. Cl. 401/6; 401/183; 401/202

(57) ABSTRACT

An applicator assembly for applying lotions to areas of the individual's body, the applicator assembly comprising a handle member squeezably deformable and telescopic in nature, said handle member serving as the container member for the lotion to be dispensed, said handle member having a removable cap at a first terminus for filling, the opposing terminus of the handle member having a plurality of apertures circumferentially disposed about the handle member, an applicator member slidably receivable on said handle member on the terminus having the plurality of apertures, the applicator member being an absorbent, deformable, resilient sponge-like member formed to contact both large and small areas of the body and a sleeve member slidably retainable over the applicator member for protection of the applicator member when not in use.

### RELATED APPLICATIONS

Applicant claims the benefit of provisional application Serial No. 60/357,790, filed Feb. 20, 2002.

### BACKGROUND OF THE INVENTION

1. Field of the Invention

The present invention relates to a liquid applicator and more particularly, to a telescoping applicator assembly for applying lotions, such as suntan lotion, moisturizing lotion, and the like, to various parts of the body.

2. Description of the Prior Art

Individuals have need to apply various types of lotions to various parts of the body. In the summer time, suntan lotion or sun blocking lotion is normally applied to all portions of the exposed skin. At all times of the year, many individuals apply moisturizing lotions or gel to various parts of the body. In some instances, individuals are required to apply medicinal ointments to specific areas of the body.

These lotions are normally packaged and purchased in plastic, squeezable, or pour containers, with the individual user dispensing the lotion onto their hands or onto a cloth and rubbing it on the desired body part. In many instances, the individual requires assistance in applying the lotion to specific body parts, i.e. the back, because the individual's hands and arms cannot reach particular areas of that location. Still further, some individuals suffer from disabilities such that they could not reach areas of the body that could be reached by an individual having no such disability.

Another drawback of lotions which are dispensed from squeezable containers or poured is that they require the use of the hands for application or in some instances a cloth for application, which requires the washing or wiping of the hands, or the disposal of the cloth. This is particularly annoying in some situations, such as when one is sunbathing at the beach, and the hands become sticky as a result of the application of the lotion.

Applicant has addressed this problem in developing an assembly which provides for a container member which is squeezable and also serves as a handle member for an applicator member which allows application of the particular lotion directly to the desired body part without contact to the hands, the container member being slidably extendable to allow the individual to reach all parts of the body, the container member being refillable from standard, purchased lotion containers, there further being a protective sleeve member slidably receivable over the applicator member to protect it when not in use.

### OBJECTS OF THE INVENTION

An object of the present invention is to provide for a novel applicator for lotions which incorporates a squeezable container for supplying the lotion.

Another object of the present invention is to provide for a novel applicator for lotions in which the container for the applicator is also the handle.

A still further object of the present invention is to provide for a novel applicator for lotions in which the handle is telescopic to allow the user to reach all parts of the body.

A still further object of the present invention is to provide for a novel applicator for lotions which is washable and reusable.

A still further object of the present invention is to provide for a novel applicator for lotions in which the application member is slidably receivable within a protective sleeve when not in use.

A still further object of the present invention is to provide for a novel applicator for lotions in which the applicator member is formed to contact both large and small areas of the body.

A still further object of the present invention is to provide for a novel applicator for lotions in which the handle member is squeezably deformable so as to dispense lotion to the applicator member.

### SUMMARY OF THE INVENTION

An applicator assembly for applying lotions to areas of the individual's body, the applicator assembly comprising a handle member squeezably deformable and telescopic in nature, said handle member serving as the container member for the lotion to be dispensed, said handle member having a removable cap at a first terminus for filling, the opposing terminus of the handle member having a plurality of apertures circumferentially disposed about the handle member, an applicator member slidably receivable on said handle member on the terminus having the plurality of apertures, the applicator member being an absorbent, deformable, resilient sponge-like member formed to contact both large and small areas of the body and a sleeve member slidably retainable over the applicator member for protection of the applicator member when not in use.

### BRIEF DESCRIPTION OF THE DRAWINGS

These and other objects of the present invention will become evident particularly when taken in light of the following illustrations wherein:

FIG. 1 is a perspective view of the applicator assembly;

FIG. 2 is a perspective view of the protective sleeve member for the applicator assembly;

FIG. 3 is a cross sectional view along plane 3-3 of FIG. 1, illustrating the cooperation between the applicator member and the terminus of the handle member;

FIG. 4 is an exploded view of the assembly; and

FIG. 5 is an exploded view of a second embodiment of the handle member.

### DETAILED DESCRIPTION OF THE DRAWINGS

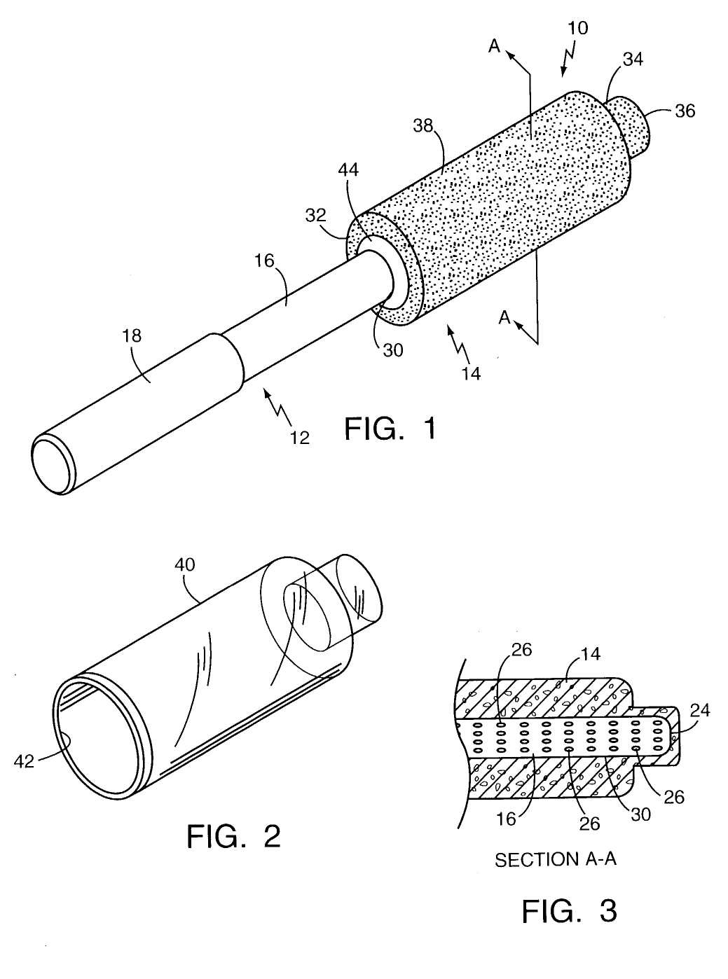

FIG. 1 is a perspective view of a first embodiment of the applicator assembly 10 with FIG. 3 being a cross sectional view of applicator assembly 10 along plane 3-3 of FIG. 1.

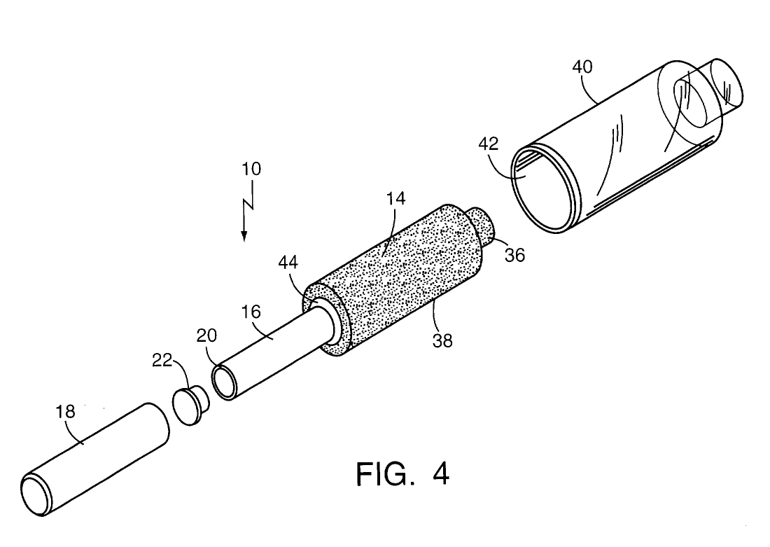

Applicator assembly 10 comprises a handle member 12 and an applicator member 14. Handle member 10 is preferably of tubular construction, having a first tubular member 16 on which applicator member 14 is mounted. A second tubular member 18 is telescopically attached to first tubular member 16 so that the applicator assembly can be extended to permit the user to reach all parts of the body. Tubular member 16 has a first terminus 20 having a removable securable cap 22 (See FIG. 4) to permit the user to introduce a lotion into first tubular member 16. First tubular member 16 is also deformable to permit the user to squeeze its circumferential side wall and thus aid in the flow of the lotion contained therein towards second terminus 24. A portion of first tubular member 16 proximate second terminus 24 has a plurality of apertures 26 about its circumferential side wall. This permits the passage of lotion through apertures 26 and into applicator member 14.

Applicator member 14 is fabricated from a sponge-like, absorbent material. Applicator member 14 is cylindrical in shape having a partial bore 30 formed in first end 32 for slidable receipt upon first tubular member 16. Second end 34 of applicator member 14 is tapered so as to form a nipple protrusion 36. Nipple protrusion 36 is utilized by the individual in applying lotion in a dab-like manner to specific portions of the body, such as sun tan lotion applied around the eyes or to the nose. The outer circumferential surface 38 of applicator member 14 is utilized to apply lotion of large surfaces of the body. There is fitted about partial bore 30 in first end 32 an annular stop member 44 which prevents lotion from seeping down first tubular member 16, annular stop member 44 may also have a circumference substantially identical to circumferential surface 38 so that the protective sleeve 40 (FIG. 2) may cooperably snap fit with it to prevent contamination of applicator member 14 when not in use.

FIG. 3 is a cross sectional view along plane 3-3 of FIG. 1 illustrating the plurality of apertures 26 and circumferential side wall of first tubular member 16 and the manner in which first tubular member 16 is inserted into partial bore 30 a distance sufficient for applicator member 14 to contain all that portion of first tubular member 16 having the plurality of apertures 26.

FIG. 2 illustrates protective sleeve 40 which is used to protect the applicator member 14 from contamination by sand, dirt, soot and the like. Protective sleeve 40 is of one piece construction, preferably of plastic, and formed to define a cavity 42 which conforms to the outer contour of the applicator member 14.

In use, second tubular member 18 would be telescopingly positioned about first tubular member 16, thus presenting the shortest handle available on applicator assembly 10. In this position, second tubular member 18 allows the user access to cap 22, which is removably secured to first tubular member 16. The user would remove cap 22 and fill first tubular member 16 with the preferred lotion. Cap member 22 would then be resecured to first tubular member 16 and second tubular member 18 could be extended to its desired length.

The user would then remove the protective sleeve 40 from applicator member 14 and contact that portion of the applicator member desired with the desired area of skin surface. The user would move the outer surface 38 of applicator member 14 over the desired portion of skin surface, while simultaneously squeezing the first tubular member 16 to encourage the passage of the lotion through the plurality of apertures 26 into the applicator member 14, thus saturating same. After the first use such as this, a portion of the lotion will be retained in the applicator member 14 and will be protected from contamination by use of the protective sleeve 40. Therefore the user will find that in subsequent applications, it will not be necessary to squeeze the tube simultaneously while contacting the desired skin surface.

In another embodiment of applicator assembly 10, applicator member 14 can be mounted onto the first tubular member 16 in the manner which allows for applicator member 14 to rotate freely and thus allow the user to roll the applicator member across the desired skin surface area. The rotation of applicator member 14 on first tubular member 16 could be accomplished in a number of different ways. One economical way would be to first mount applicator member 14 on an apertured sleeve 44 positioned within partial bore 30 with this apertured sleeve slidably rotatably securable on first tubular member 16 and rotatable thereabout thus imparting the rotational ability to applicator member 14.

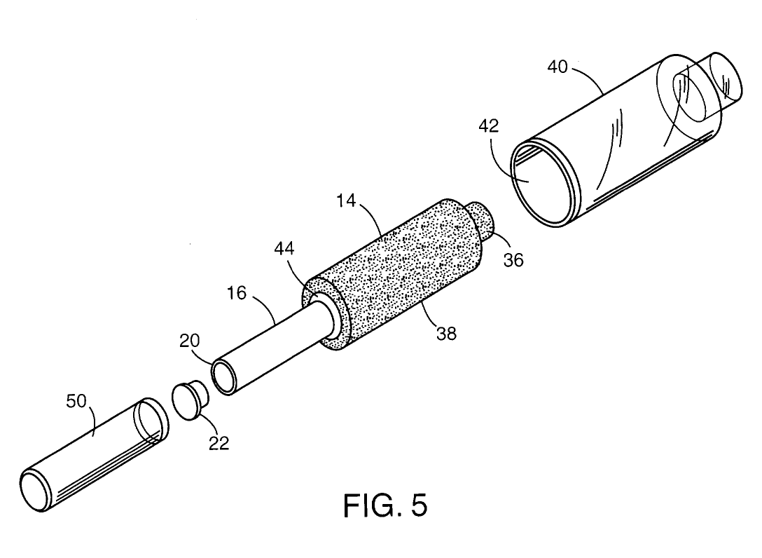

A further embodiment of the present invention without departing from its spirit and scope would be to modify handle member 10 so as to still include a first tubular member 16 and cap 22. However, second tubular member 18 would be replaced by a frame member 50 as illustrated in FIG. 5 which would telescope with first tubular member 16 and be capable of being locked in place in the telescopic extended position for reaching difficult areas of the skin surface, but when in the unextended position would allow easier access to the cap member 22. Frame member 50 would have longitudinal slots cooperative with raised longitudinal protrusions on first tubular member 16 to allow the user to depress these protrusions so as to cause the flow of lotion to applicator member 14.

In a still further embodiment to the applicator assembly 10, the second tubular arm 18 could be eliminated and protective sleeve 40 could be formed with an attachment assembly on its closed end such that when protective sleeve 40 is disengaged from the applicator member 14, it could be secured to the end of first tubular member 16, thus providing for an extended handle to reach difficult places on the surface of the body. The manner of securing the protective sleeve to the first tubular member could vary, but one method would be to provide for exterior threads on the end of the first tubular member 16 and an interiorly threaded bore on the closed end of protective sleeve 40 such that the two could be threadedly fastened and unfastened as the user required.

It will be recognized by those skilled in the art that the dimensions of the applicator assembly 10 can be varied without departing from the spirit and scope of the invention. Applicant believes that the optimum dimensions would be an applicator member 14 being approximately 6 inches in length with the main body being approximately 4 inches in length, and the nipple end 36 being approximately 2 inches in length. The first tubular member 16 of the handle member 10 would extend outwardly from the applicator member a distance of approximately 5½ inches, with first tubular member 16 being 5 inches in circumference to provide for an adequate reservoir of lotion. The second tubular member 18 would extend the handle member 10 an addition 4 to 4½ inches and thus provide an applicator assembly when fully extended of a length of between 15 and 16 inches, which length has been determined to enable the user to comfortably position the applicator member on any portion of the skin surface of the body that the user so desires.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. An applicator assembly for applying lotions to areas of a user's body, the applicator assembly comprising:
a first tubular handle member having a first end and a second end, said first end for inputting a lotion into said first tubular handle member, said second end and said area of said first tubular handle member proximate thereto having a plurality of perforations therethrough;
a removable sealing means for said first end of said first tubular member;
an absorbant, resilient, sponge-like applicator member, having a partial bore therethrough, said bore slidably receivable over said second end of said first tubular member and said perforations formed therein, said first end of said first tubular handle member deformable by hand pressure to urge lotion through said perforations in said second end of said first tubular member and into said absorbant, resilient, sponge-like applicator member for application to the skin of said user's body.

2. The applicator assembly in accordance with claim 1 wherein said applicator member is cylindrical in shape and having a tapered end.

3. The applicator assembly in accordance with claim 1 wherein said applicator member is frictionally engaged with said first tubular handle member.

4. The applicator assembly in accordance with claim 1 wherein said applicator member is rotatably engaged with said first tubular handle member.

5. The applicator assembly in accordance with claim 1 wherein a second tubular member is slidably lockable in relationship to said first end of said first tubular member so as to provide extension to said first tubular member for reaching parts of the skin of the user's body.

6. The applicator assembly in accordance with claim 1 wherein said applicator member includes a protective sleeve slidably engageable about said applicator member when not in use.
